(19) United States
(12) Patent Application Publication
(10) Pub. No.: US 2004/0245901 A1
(43) Pub. Date: Dec. 9, 2004

(54) High intensity discharge headlight structure

(76) Inventor: Jung-Tsung Yang, Hsinchu City (TW)

Correspondence Address: Jung-Tsung Yang, P.O. Box No. 6-57, Junghe, Taipei 235, TW

(21) Appl. No.: 10/455,301

(22) Filed: Jun. 6, 2003

(51) Int. Cl. H01J 61/30; H01J 17/16

(52) U.S. Cl. 313/17; 313/317; 313/634

(57) ABSTRACT

A high intensity discharge (HID) headlight structure according to the invention includes a light bulb base and a light tube. One end of the light bulb tube is provided with a positioning base consisted of an upper cover and an accommodating washer. The light tube is fastened in the light bulb base via the positioning base. An interior of the light tube is provided with a light source having a positive electrode and a negative electrode. An exterior of the light source is a light capsule as a formed integral. The positive and negative electrodes are penetrated to an exterior via two ends of the light capsule. One electrode of the positive and negative electrodes, after being penetrated out of the light capsule, is bent by two times, connected with a conductor, and accommodating by an accommodating tube.

### BACKGROUND OF THE INVENTION

(a) Field of the Invention

The invention relates to a high intensity discharge (HID) headlight structure, and more particularly, to an HID headlight structure having a headlight capsule as an integral.

(b) Description of the Prior Art

A new mainstream in the twenty-first century vehicle headlights, high intensity discharge (HID) headlights, has been launched by leading automobile manufacturers worldwide, and have gained praises and excellent feedbacks.

In conventional light bulbs, tungsten filaments are utilized for illumination. However, in HID systems, principles of high intensity discharge are adopted for elevating voltages to above 23000 volts using high technology and high precision ballasts. Electric arcs are produced within light tubes with combustion of xenon for illumination, and such being the origin of HID.

HID illumination techniques are also extensively applied in illumination of various sports arenas. Light intensities of HID lamps are too intense for direct observation of naked eye for that light intensities of HID lamps are three times of those of conventional halogen lamps. Yet, power consumption of HID lamps is merely 50% of that of conventional halogen lamps. To be more precise, power consumption of HID lamps is 35 W, whereas that of halogen lamps is 55 to 65 W. Consequently, for a vehicle that uses HID lamps, more power is reserved for other power systems of the vehicle in order obtain more thorough power utilization.

Therefore, many leading manufacturers have long since devoted to researches and development of HID lamps. Referring to FIG. 7 showing a “Capsulated HID Lamp” in the proprietary of Philips Electronics N. V., the HID lamp comprises a light source having a tube that is sealed in an airtight condition. Wherein, a filling for filling up with gases to be ionized, and first and second neck portions have an airtight sealing, respectively. First and second power supply conductors are extended to and arranged in a pair of electrodes in the light tube after passing through the neck portions. Through the first neck portion, the light tube is fastened to a lamp capsule made of insulation materials. The lamp capsule has a first contact member thereof connected with the first power supply conductor and a second contact member thereof connected with the second power supply conductor. A connecting conductor is extended to the lamp capsule toward a direction of the light tube, and is connected with the second power supply conductor and the second contact member. The light tube has a concentric tube-like outer capsule filled with air. The characteristics of the capsulated HID lamps are that, the connecting conductor is extended toward an exterior of the outer capsule, and the outer capsule is in fact a circular and narrow portion surrounded by the light source.

However, the aforesaid capsulated HID lamp has characteristics that can be advanced. For instance, a coupling joint of the second power supply conductor and the connecting conductor at an exterior of the narrow portion of the outer capsule, is perpendicular to the second power supply conductor and the connecting conductor, and lacks members for securing and protection. Therefore, this structure is likely to loosen due to various reasons, and thus leading to poor contact thereof.

Furthermore, an airtight space is required for filling gases by HID lamps, and formation of the airtight space is another task worth discussion.

### SUMMARY OF THE INVENTION

The primary object of the invention is to provide an HID headlight structure capable of providing better stability and efficiency, as well as preventing electromagnetism.

### BRIEF DESCRIPTION OF THE DRAWINGS

FIG. 1 shows an elevational view according to the invention.

FIG. 2 shows an exploded elevational view according to the invention.

FIG. 3 shows a side view according to the invention.

FIG. 4 shows a bottom view according to the invention.

FIG. 5 shows a sectional view along A-A according to the invention.

FIG. 6 shows a metal shield in another embodiment according to the invention.

FIG. 7 shows a “Capsulated HID Lamp” in the proprietary of Philips Electronics N. V.

### DETAILED DESCRIPTION OF THE PREFERRED EMBODIMENTS

To better understand the technical contents of the invention, detailed descriptions shall be given with the accompanying drawings hereunder.

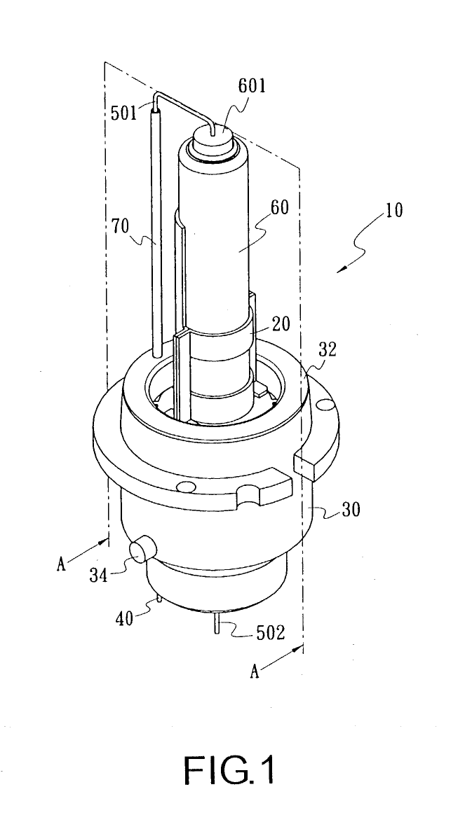

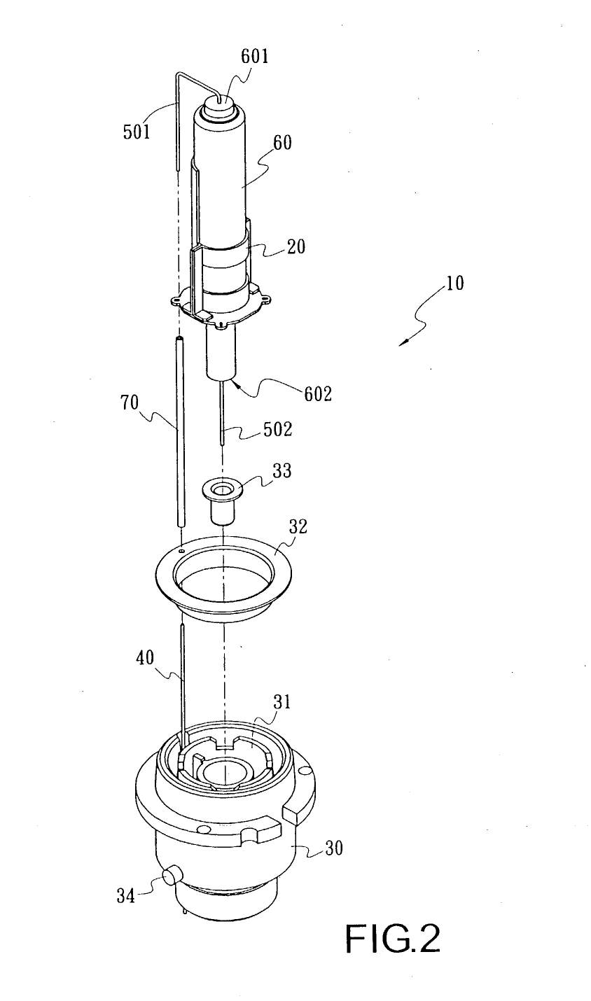

Referring to FIG. 1 and 2, an HID headlight 10 according to the invention comprises a light bulb base 30 and a light tube 50. An interior of the light bulb base 30 is disposed with a positioning base 31 further provided with an upper cover 32 and an accommodating washer 33. A rear end of the light tube 50 is accommodated by the accommodating washer 33, and is fastened to the positioning base 31. Using the covering of the upper cover 32, the entire light tube 50 is mounted onto the light bulb base 30.

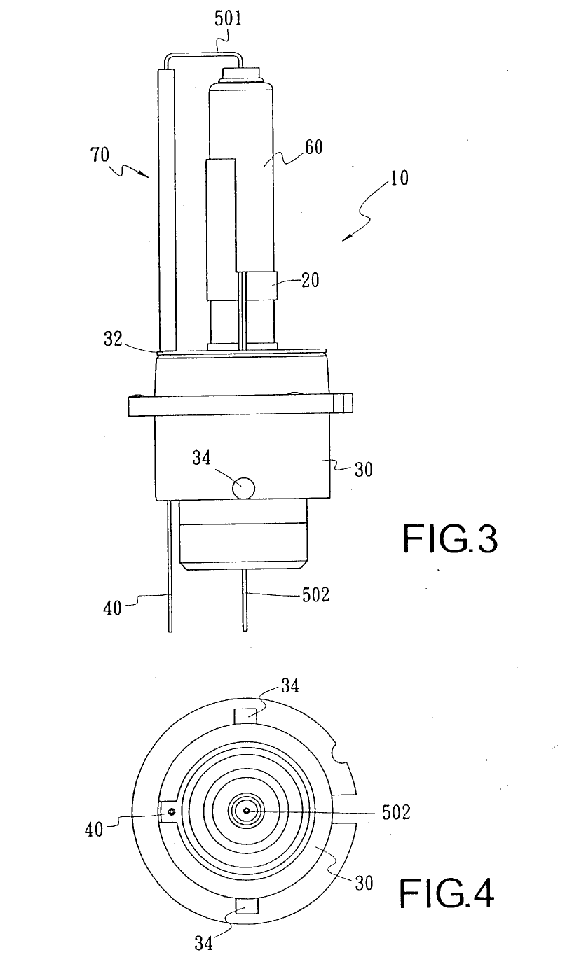

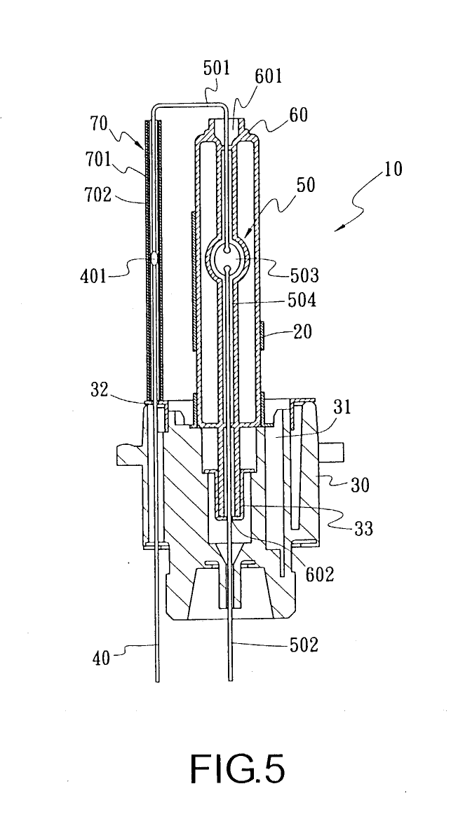

In addition, the light tube 50 includes an electrode having a positive electrode 501 and a negative electrode 502, and a light source 503. Referring to FIGS. 3, 4 and 5, the light source 503 is enveloped with a light capsule 60 as a formed integral. A lower portion of the light capsule 60 is wrapped with a metal shield 20, which is an integral formed by extrusion, and is bent and wrapped around the light capsule 60. The metal shield 20 is for protecting the light capsule 60 and for serving as a shield of the light source, such that light beams emitted by the light source 503 are enabled to travel toward a same direction. The light bulb base 30 is further provided with a pair of corresponding retaining protrusions 34 for fastening the HID headlight 10 with other bases.

The positive and negative electrodes 501 and 502 are extended outward via two end portions 601 and 602 of the light capsule 60. Wherein, the positive electrode 601 is penetrated out of the light capsule 60, bent by 90 degrees for two times, and connected to another conductor 40 with a formed connection point 401. The connection point 401 is on one side of the light capsule 60, and is located on a same axial direction as the electrode 501 and the conductor 40. The connection point 401, and the electrode 501 and the conductor 40 near the connection point 401, are further accommodated by an accommodating tube 70. The accommodating tube 70 is for preventing electromagnetism, and is consisted of inner and outer layers 701 and 702. The inner layer 701 is made of Teflon, the outer layer 702 is made of porcelain, and the accommodating tube 70 is penetrated through an opening 321 of the upper cover 32. The opening 321 is for penetrating and fastening the accommodating tube 70, and for providing the connection point 401, the electrode 501, and the conductor 40 with supportive and securing effects. Using the aforesaid design, the conductor 40 and the electrode 501 are allowed with a same pole, which is the positive pole in this embodiment, such that the conductor 40 having a positive pole and the negative electrode 501 are located in a same direction while having an appropriate distance in between.

The characteristics of the invention are that, the light capsule 60 is a formed integral, and the light tube 50 is encapsulated therein during manufacturing. Moreover, an interior of the light tube 50 is further formed with an airtight chamber 504 for filling with specific gases. For that the light capsule 60 provides protective effects against ultraviolet and prevents cracking, and the light tube 50 is also encapsulated therein, safety thereof is increased.

Conclusive from the above, the HID headlight according to the invention, apart from the characteristic of having the light capsule 60 as a formed integral, has the connection point 401, the electrode 501 and the conductor 40 thereof located on a same axial direction instead of being located on bent portions therein. Through these characteristics, the invention has the following excellences:

1. The light capsule 60 as a formed integral is different from conventional light capsules. A light tube 50 is airtight sealed at a light source thereof, and an airtight chamber 504 in the light tube 50 is formed for filling with gases. This type is structure has a style and manufacturing method distinct from those of the prior art, and is capable of reducing production expenses in material and processing costs.

2. A connection point 401 is formed in a same direction as the electrode 501 using welding, and is different from the electrode 501 and the conducting 40 that are formed perpendicularly in the prior art, thereby eliminating loosening and defective rate in welding caused by conventional welding processes.

3. The accommodating tube 70 is unlike the design of common ceramic tubes. A Teflon layer is added as an inner layer of the accommodating tube, thereby preventing high-voltage electricity and electromagnetic waves produced thereto.

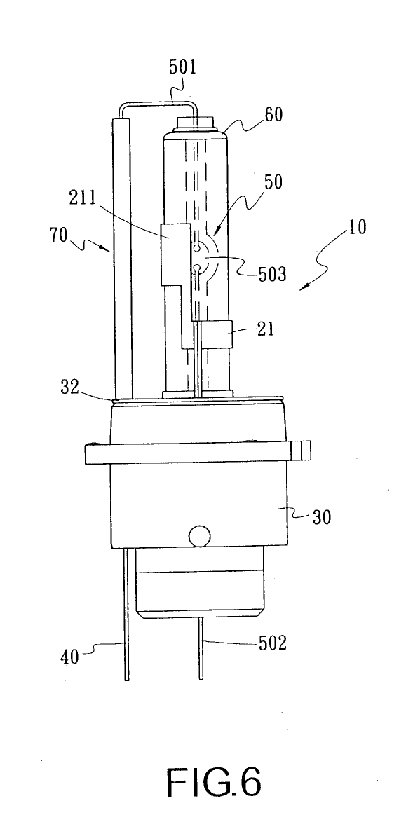

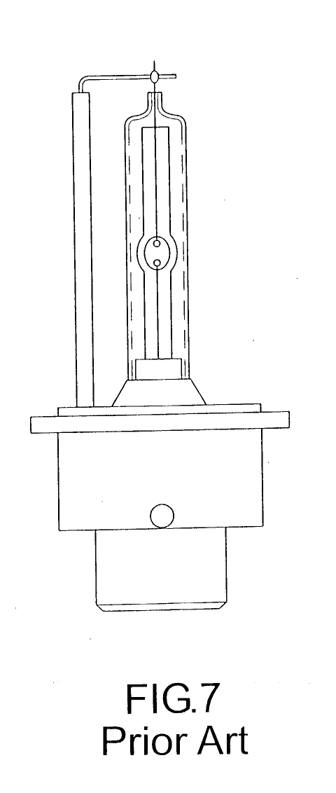

Referring to FIG. 6 showing the aforesaid metal shield 20 in another embodiment according to the invention, a metal shield 21 is similarly a formed integral, and is bent and wrapped around the light capsule 60. Two sides of the metal shield 21 are formed with corresponding pieces 210 extended to a front end for forming a shield portion 211. The shield portion 211 is corresponding to the light source 503 of the light tube 50 for serving as a shield of the light source, such that light beams emitted by the light source 503 are enabled to travel toward a same direction.

It is of course to be understood that the embodiments described herein are merely illustrative of the principles of the invention. A wide variety of modifications thereto may be effected by persons skilled in the art without departing from the spirit and scope of the invention as set forth in the following claims.

What is claimed is:

1. A high intensity discharge (HID) headlight structure comprising a light bulb base, a light tube and an accommodating tube, wherein one end of the light tube base has a positioning base provided with an upper cover and an accommodating washer for fastening to the light tube, and the characteristics thereof are that:
an outer periphery of the light tube is a light capsule that is a formed integral; an interior of light tube is a light source having a positive electrode and a negative electrode; and the positive and negative electrodes are penetrated via upper and lower ends of the light capsule; wherein one end of one of the electrodes is penetrated out of the light capsule, bent by two times, connected with a conductor, and accommodated by an accommodating tube.

2. The HID headlight structure in accordance with claim 1, wherein the accommodating tube is consisted of inner and outer layers, with the inner tube being Teflon and the outer layer being porcelain, thereby forming an accommodating tube capable of preventing electromagnetism.

3. The HID headlight structure in accordance with claim 1, wherein an interior of the light tube is an airtight chamber for filling with specific gases.
